(19) United States
(12) Patent Application Publication
(10) Pub. No.: US 2005/0002604 A1
(43) Pub. Date: Jan. 6, 2005

(54) Resonant cavity enhanced photodetector, corresponding matrix and telecommunication system

(75) Inventors: Vivien Verbrugge, Rennes (FR); Loig Plouzennec, La Haye (FR); Jean-Louis De Bougrenet De La Tocaye, Guilers (FR)

Correspondence Address: MERCHANT & GOULD PC, P.O. BOX 2903, MINNEAPOLIS, MN, 55402-0903, US

(73) Assignee: OPTOGONE, Plouzane (FR)

(21) Appl. No.: 10/879,900

(22) Filed: Jun. 28, 2004

(30) Foreign Application Priority Data
Jul. 3, 2003 (FR) FR 03 08140

(51) Int. Cl. G02B 6/28

(52) U.S. Cl. 385/24

(57) ABSTRACT

The invention relates to a resonant cavity enhanced photodetector (10, 60) comprising a first (20) and a second (21) reflection means forming the said cavity and means of absorption (22) of photons of an incident light beam (17), characterised in that it also comprises at least one electro-optical element inside the said cavity, intended for tuning the wavelength of the said photodetector. The invention also relates to a matrix of several photodetectors and a corresponding telecommunication system.

### DOMAIN OF THE INVENTION

This invention relates to the domain of optical components, and more precisely to resonant cavity enhanced (RCE) photodetectors.

1. State of Prior Art

RCE photodetectors are described particularly in the article “Design of a resonant cavity enhanced photodetector for high-speed application” written by Tung and Lee and published in the IEEE journal of quantum electronics in May 1997. RCE photodetectors have several advantages over other photodetectors. Firstly, they have better external quantum efficiencies and a wide pass-band. They also have a gain when they are used under avalanche conditions.

One disadvantage of the RCE photodetectors according to the state of the art is that they can detect only one wavelength, which is only dependent on the manufacturing method.

2. Purposes of the Invention

The various aspects of the invention are intended to overcome these disadvantages of prior art.

More precisely, one purpose of the invention is to provide a photodetector that is tuneable as a function of the wavelength that is to be detected.

Moreover, one purpose of the invention is to enable the photodetector to precisely set itself on channels that can drift naturally in time and/or vary following changes in the emitter or its wavelength.

Another purpose of the invention is to provide a photodetector that is relatively simple to make.

Yet another purpose of the invention is to enable a high photodetection speed compatible with many applications (particularly high-speed data transfer applications) and with high sensitivity.

### PRESENTATION OF THE INVENTION

Therefore, the invention is based on a resonant cavity enhanced photodetector comprising a first and a second reflection means forming the cavity and means of absorption of photons of an incident light beam, the photodetector also comprising at least one electro-optical element inside the cavity that will tune the wavelength of the photodetector.

According to one particular characteristic, the photodetector is remarkable mainly in that it also comprises first means of application of a variable electrical field to the electro-optical element as a function of at least an electrical voltage applied to the photodetector.

Thus, it is fairly easy to tune the photodetector as a function of the wavelength to be detected.

According to one particular characteristic, the photodetector is remarkable in that the first means of application of an electrical field comprise at least one first transparent or semi-transparent electrode enabling application of the electrical field to the electro-optical elements and passage of the incident light beam through these electrodes.

Thus, the light beam(s) received by the photodetector can pass through the electrodes, which are also adapted to creating an appropriate electrical field in the electro-optical element(s).

According to one particular characteristic, the photodetector is remarkable in that the first electrode(s) is (are) of the ITO type.

The photodetector is thus relatively compact and easy to make.

According to one particular characteristic, the photodetector is remarkable in that at least one of the electro-optical elements comprises a material that is isotropic in a transverse plane.

Note that for the purposes of this presentation, a “transverse plane” is a plane perpendicular to an axis of propagation of the light beam(s) received by the photodetector and passing through the plane.

For the purposes of this presentation, an “isotropic material” means a material isotropic at the wavelength(s) considered (in other words the wavelength(s) received by the photodetector).

The material is isotropic in a transverse plane, which is sufficient to obtain a photodetector with behaviour insensitive to polarisation.

According to one particular characteristic, the photodetector is remarkable in that at least one of the electro-optical elements comprises a nano-PDLC type material.

The result is advantageously a material with good optical characteristics and that is easy to use, for example by deposition and etching.

According to one particular characteristic, the photodetector is remarkable in that the photon absorption means comprise a bulk absorbent zone.

According to one particular characteristic, the photodetector is remarkable in that it comprises second means of application of an electrical field to the absorbent zone.

Thus, the photodetector uses second means of applying an electrical field to the absorbent zone such that detection is more efficient and more reliable and does not require any external amplification means.

According to the invention, the first and second means of application of an electrical field may comprise parts in common. Thus, according to a preferred embodiment of the invention, they comprise a first common electrode (for example transparent, semi-transparent or annular), subjected to an electrical potential (for example the ground), which simplifies use of the photodetector and reduces its size.

Depending on particular embodiments of the invention, the second means of application of an electrical field also comprise an electrode enabling photoelectric detection. For example, this electrode is made of gold and is preferably adjacent to reflection means (to simplify use and to reduce the size of the photodetector).

According to one particular characteristic, the photodetector is remarkable in that the optical loss profile of the electro-optical element(s) is (are) variable in a plane perpendicular to an axis of propagation of the light beam so as to favor a transverse mode of the photodetector.

Thus, the photodetector is suitable for receiving and detecting beams in particular transverse modes; in particular, fundamental transverse mode or first transverse mode. The result is that better immunity to noise is obtained if the received beam to be decoded operates on a single transverse mode. Therefore, this profile provides a flexible and easy means of giving priority either to fundamental transverse mode, or to another mode.

The invention also relates to a matrix of components comprising at least two photodetectors as described previously according to the invention.

Thus, the invention provides a means of obtaining photodetector components at low cost or small components capable of treating an incident beam with several wavelengths.

According to one particular characteristic, the matrix of components is remarkable in that each photodetector in the matrix comprises:
means of application of an electrical field for tuning a wavelength associated with the photodetector, such that the matrix is capable of tuning several wavelengths;
and detection means associated with each of the tuned wavelengths.

Thus, the matrix is capable of receiving a beam with several wavelengths and treating each wavelength in a separate and flexible manner (the tuneability and therefore the detected wavelength can vary on request) that is easy to use (associating the photodetector with a particular wavelength is equivalent to suitably choosing the electrical field applied to the corresponding photodetector in the matrix).

The invention also relates to a high-speed communication system, remarkable in that it comprises means of reception of at least one incident beam, themselves including at least one resonant cavity enhanced photodetector as described above.

According to one particular characteristic, the system is remarkable in that the reception means comprise means of redirection of an incident beam to each of the photodetectors.

Thus, the photodetectors may be used in parallel, which is particularly useful for high-speed applications.

According to one particular characteristic, the system is remarkable in that the redirection means form a coupler.

According to one particular characteristic, the system is remarkable in that the reception means comprise at least two photodetectors adapted to detecting light beams with distinct wavelengths.

According to one particular characteristic, the system is remarkable in that it comprises means of emission of the incident beam(s).

The advantages of the matrix and the photodetection system are the same as for the photodetector and they are not described in more detail.

### LIST OF FIGURES

Other characteristics and advantages of the invention will become clearer after reading the following description of a preferred embodiment, given as a simple illustrative and non-limitative example, and the attached drawings among which:

FIG. 1 shows a perspective general layout view of a photodetector according to a particular embodiment of the invention;

FIGS. 2, 3A and 3B show a principle diagram of the photodetector in FIG. 1;

FIGS. 4A, 4B and 4C present a fabrication process for the photodetector in the previous figures;

FIG. 5 shows quantum efficiency spectra of the photodetector presented with reference to FIG. 1;

FIG. 6 shows a communication system using photodetectors like those presented in the previous figures.

The general principle of the invention is based on the use of a variable phase zone in a photodetector thus used to tune the wavelength of the photodetector. This variable phase zone may for example be obtained by application of an electrical field onto a cavity filled with nano-PDLC. In particular, the electrical field may be obtained by means of an ITO type transparent electrode or a circular electrode.

### DESCRIPTION OF A PREFERRED EMBODIMENT OF THE INVENTION

We will now diagrammatically present a preferred embodiment of a tuneable RCE photodetector 10 that will be fitted with an optical beam 17 with wavelength λ (not to scale).

Note that the photodetector 10 is subjected to different electrical potentials:
a detection potential V_{det} of the light beam 17 is applied to a point 16;
a potential V_{nPDLC} is applied to point 14 and is used to tune the detection wavelength of the photodetector 10; and
a zero potential is applied to point 15.

The detection potential difference V_{det} is applied between points 15 and 16 to polarize the photodetector side and in particular to accelerate electron—hole pairs enabling photodetection.

The photodetector 10 is adapted to receiving an optical beam 17 with wavelength λ along a propagation axis z, the photodetector 10 preferably being approximately axially symmetric about this axis. This beam may be received in free space or from one or several optical fibres associated with the photodetector 10.

According to another variant of the invention used particularly to make a photodetector matrix to form a component detecting distinct wavelengths or several separate components, points 14 and 16 are subjected to several potentials VnPDLCλ₁, VnPDLCλ₂, . . . VnPDLCλᵢ, VnPDLCλₙ and Vdetλ₁, Vdetλ₂, . . . Vdetλᵢ, Vdetλₙ, etc. Each of these potentials is connected to an ITO electrode etched on a substrate (for example transparent glass) and made of gold deposited on a Bragg mirror perpendicular to the axis of the photodetector 10, and associated with a particular detection wavelength. Thus, an electrode at potential VnPDLCλ₁ and an electrode facing it (along the z direction) at potential Vdetλᵢ are used to tune a variable phase zone at wavelength λ₁ and to bias the corresponding detection zone of the photodetector 10. The potentials VnPDLCλᵢ are equal to a value that depends on the structure of the photodetector and are preferably identical (of the order of −10 V corresponding to the avalanche voltage).

If a component including several electrodes detects several distinct wavelengths, the input beams can then in particular be input from different optical fibres. In particular, all electrodes can form paving on the substrate or the Bragg mirror so as to optimise the number of electrodes as a function of the available area; thus according to the invention, a substrate or a Bragg mirror can be made on which nine uniformly distributed electrodes are printed arranged in a matrix of three rows each comprising three electrodes.

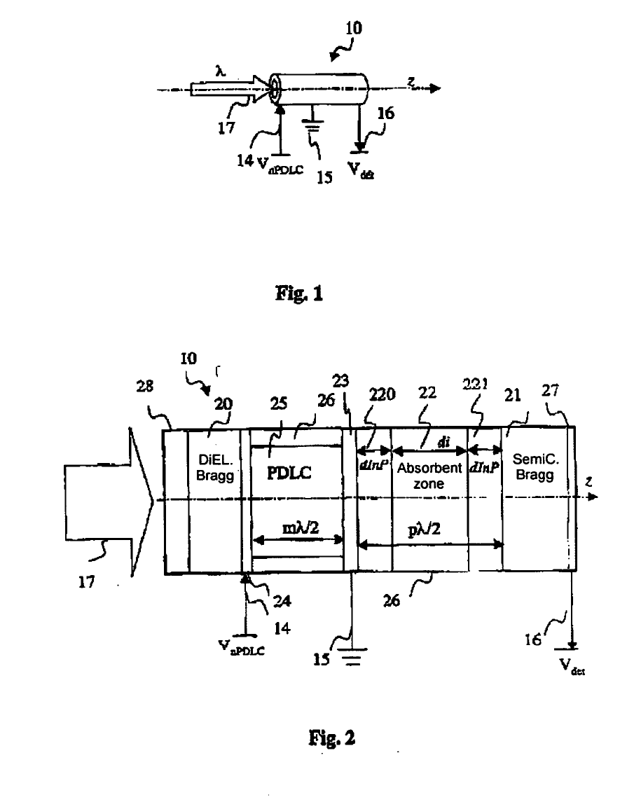

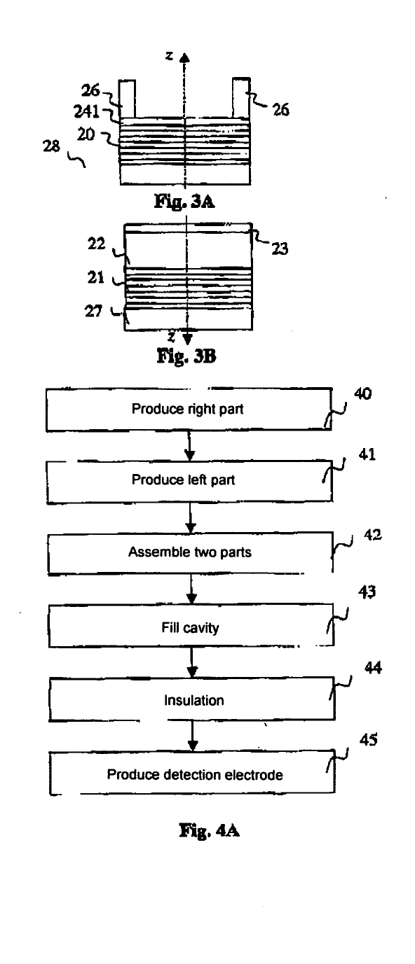

FIG. 2 diagrammatically shows the principle of the photodetector 10 as shown with reference to FIG. 1, in the form of a longitudinal section.

The photodetector 10 comprises a cavity closed by two Bragg mirrors:
a semiconducting Bragg mirror 21 with 44.5 pairs, with elements having indexes equal to 3.41 and 3.16 respectively at a wavelength equal to 1.55 μm, in 1.45 μm quaternary (denoted Q1.45) and InP respectively, a gold electrode 27 being deposited on a mirror 21 (a semiconducting Bragg mirror being easier to make than a dielectric Bragg mirror, the active zone, the Bragg mirror itself possibly being made in a single step corresponding to successive and repeated depositions of an InP and 1.45 μm quaternary layer); and
a DBR type dielectric Bragg mirror made of SiO₂ and TiO₂ with 3.5 pairs of indexes equal to 1.46 and 2.23 to 1.55 μm respectively adjacent to a transparent substrate 28.

The mirrors 20 and 21 are perpendicular to the longitudinal z reception axis of the light beam 17 (in other words they are in a transverse plane).

The beam 17 is detected by the electrode to which the potential Vdet is applied, and a current is created proportional to the quantity of incident light. The substrate 28 is used for reception of the beam 17 through appropriate optics (for example coupling micro-lenses).

Thus, the Bragg mirrors 20 and 21 are calculated to be highly reflective at 1.55 μm (99.7% reflectibility for the Bragg mirror 20 and 99.8% for the mirror 21).

The cavity includes the following elements in sequence:
an absorbent (bulk) zone 22 made of InGaAs (Indium Gallium Arsenic) with index 3.3, with absorption coefficient a equal to 1.2 μm⁻¹ and thickness di equal to 25 nm sandwiched between two neutral zones 220 and 221 made of InP with an index equal to 3.16 and thickness dInP equal to 110 nm;
a first electrode 23 made of gold connected to the zero electrical potential 15;
a variable phase zone 25 containing a nano-PDLC type liquid crystal, the zone 25 being closed on the sides by a polyimide layer 26; and
an ITO type electrode 24 perpendicular to the z axis connected to the potential V_{nPDLc} adjacent to the mirror 20.

The variable phase zone 25 has an index equal to approximately 1.55 and a length equal to approximately 1 μm depending on the wavelength λ.

The electrodes 23 and 24 are sufficiently thin (for example 10 nm) so that they can be considered to be transparent.

The application of a variable electrical field E created by the potential difference between the electrodes 23 and 24 and applied parallel to the direction of propagation of the light beam (along the z axis of the photodetector 10) to the variable phase zone 25 provides a means of tuning the cavity resonant wavelength. The result is a variation in the detection wavelength of the photodetector by 20 nm around 1.55 μm for a potential V_{nPDLc} equal to 100 Volts.

The low reflection at the semiconductor/nano-PDLC interface overcomes the need for an anti-reflection treatment which would complicate the structure and reduce the longitudinal overlap factor for the same length of the cavity and the phase shift zone.

However, for some embodiments it would be possible to use an anti-reflection coating.

The numbers of pairs of mirrors are calculated such that the width of the external quantum efficiency at mid-height is small enough and such that their reflectivities approximately satisfy the relation maximising the external quantum efficiency, namely R₁=R₂ exp(−2 α_{eff}di) where α_{eff} is equal to the product αS, where α represents the absorption coefficient of InGaAs and S is a parameter taking account of the effect of the stationary field (the absorbent zone being located on a maximum of the stationary field, the value of S being estimated at 1). The adjustment of the thickness of the InGaAs layer provides a means of more precisely satisfying the previous relation.

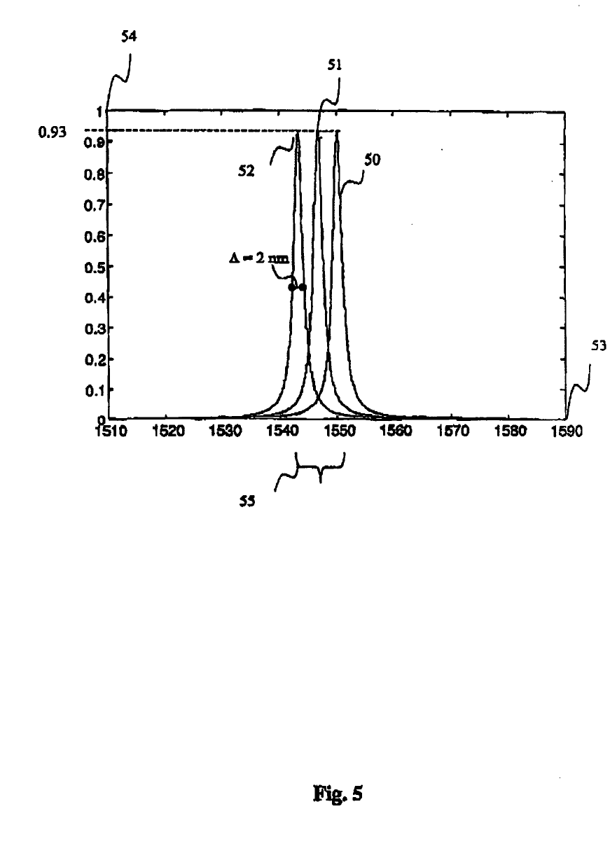

FIG. 5 illustrates the external quantum efficiency spectrum 54 of the photodetector 10 as a function of the wavelength 53 (expressed in nm) for different bias voltages V_{nPDLC} of the variable phase zone 25 equal to 0 V, 21 V and 45 V respectively, corresponding to curves 50, 51 and 52 respectively. The external quantum efficiency 54 is calculated using the transfer matrices method. The voltages V_{nDPLC} 0 V, 21 V and 45 V applied to bias the zone 25 cause detection of light at central wavelengths equal to 1555 nm, 1550 nm and 1545 nm respectively with a pass band of 2 nm.

The absorption coefficient of In GaAs α is considered constant as a function of the wavelength since it varies only slightly on the cavity tuneability range. The loss coefficients of the other semiconductor layers in the structure are negligible compared with α. The loss coefficient in the layer of nano PDLC decreases from 15×10⁻⁴ to 3×10⁻⁴ μm⁻¹ as a function of the voltage applied. It is also negligible compared with α. A quantum efficiency of about 93% with a pass-band Δ at mid-height equal to about 2 nm is obtained over the entire cavity tuneability range 55 between 1545 and 1555 nm. The small variations of the quantum efficiency (variations due to the variation in the reflectivity of Bragg mirrors) as a function of the applied voltage are essentially due to the small variations of reflectivities of mirrors as a function of the resonant wavelength.

It has a gain, provided that the photodetector 10 is inversely biased with a voltage close to the breakdown voltage (in this case of the order of a few tens of volts dependent on the structure of the photodetector in the general case) enabling an avalanche condition. This gain is quantified using the multiplication factor M in the avalanche condition. This multiplication condition leads to an internal amplification process for the photocurrent. This reduces constraints on an external electronic amplification circuit that limits the increase in cost, the size of the system and the impact on the pass-band.

Moreover, for a sufficiently small area of the photodetector 10, the pass band [0ƒₜᵣ] of the photodectector is determined by the cut off frequency (frequency at which 3 dB are lost on the output signal) related to the carrier transit time in the absorbent zone 22. It is expressed by the following relation:

$${f}_{tr} = 0.45 \frac{( {V}_{h} )}{{d}_{i} + 2 {d}_{InP}}$$

where vₕ is the hole displacement velocity (slowest carriers) in the absorbent zone.

Thus, the theoretical cutoff frequency is about 100 GHz in the case of an electrical field applied to the semiconducting zone of the cavity through V_{def}, saturating the velocity of holes at 107 cm/s.

Making the Various Parts of the Component

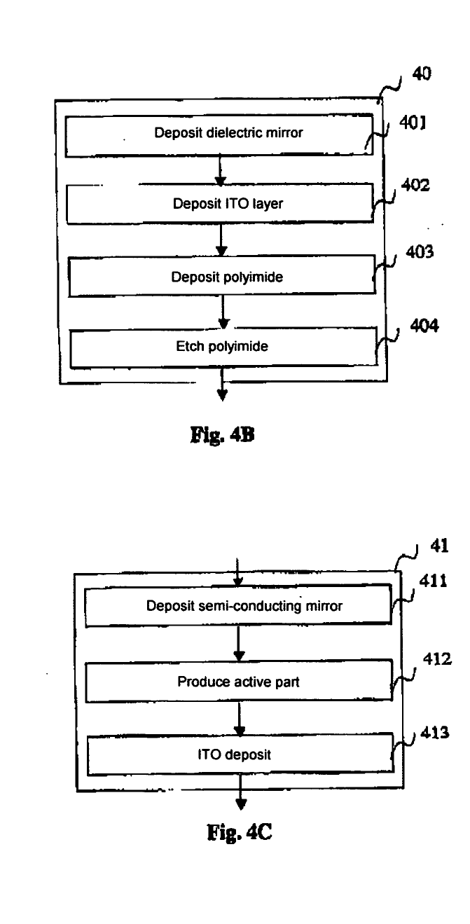

FIG. 3A more precisely describes the end comprising the cavity 25 filled with nano-PDLC of the photodetector 10 on which the light beam is received and FIG. 4B shows its implementation.

This end of the component (left part in FIG. 2A) is manufactured 40 in several steps:

In a first step 401, the dielectric Bragg mirror 20 is deposited on a glass plate 28 with optical quality by vacuum deposition.

Then, during a step 402, a thin layer of ITO is deposited to form the first electrode enabling biasing of the nano-PDLC layer.

According to one variant described above that independently detects several wavelengths, the ITO layer is etched to produce circular electrodes (replacing the electrode 24) that are to be biased independently.

In the next step 403, a sacrificial layer 26 of polyimide is deposited using the spinner with a thickness controlled to within 2%.

Then during a step 404, this layer is selectively etched so as to leave pads so that this part can then be brought into contact with the second part of the photodetector 10, leaving a space with a thickness controlled to within about 2% in the cavity that can be filled with nano-PDLC.

FIG. 3B more precisely describes the opposite end of the photodetector 10 and FIG. 4C describes its embodiment.

The end comprising the zone 22 comprising the semiconducting Bragg mirror 21 (right part in FIG. 2A) is also manufactured 41 in several steps.

During a first step 411, the semiconducting Bragg mirror is made by successive vacuum depositions of pairs (epitaxy) on an InP substrate 30.

The active part 22 of the component is then grown by epitaxy during a step 412.

A thin layer of ITO forming the electrode 23 connected to the ground 15 is then deposited during a step 413.

FIG. 4A describes production of the photodetector 10 more globally.

The two parts of the component are made as illustrated with reference to FIGS. 4B and 4C, during the first two steps 40 and 41.

Then the two parts of the component thus made are brought into contact in a step 42.

The cavity formed by the assembly of the two parts is then filled with a mix of liquid crystal and liquid polymer, during a step 43.

During a step 44, the mix is then insolated to make the polymer polymerise and thus form liquid crystal droplets in the solidified matrix of polymer (nano-PDLC), which glues the two parts of the photodetector.

The manufacturing process for the variable phase zone requires UV (ultra-violet) insolation of the liquid crystal/polymer mix placed in cavity 25 through the dielectric Bragg mirror 20. The UV power used, denoted Pᵤᵥ, controls the size of the liquid crystal droplets dispersed in the polymer matrix and therefore the value of the loss coefficient associated with diffusion in the phase zone.

During a step 45, after selective chemical etching of the substrate 30, a metallic layer (preferably gold) is then deposited on the Bragg mirror 21 to form the electrode 27.

According to one previously described variant that is capable of detecting several wavelengths independently, the metal layer is etched to make several circular detection electrodes (replacing the electrode 27), each of the detection electrodes facing a corresponding electrode (along the z direction) so that the wavelength can be tuned. A matrix of independent components or a component detecting several wavelengths can thus be made.

Description of a Demultiplexing System According to the Invention

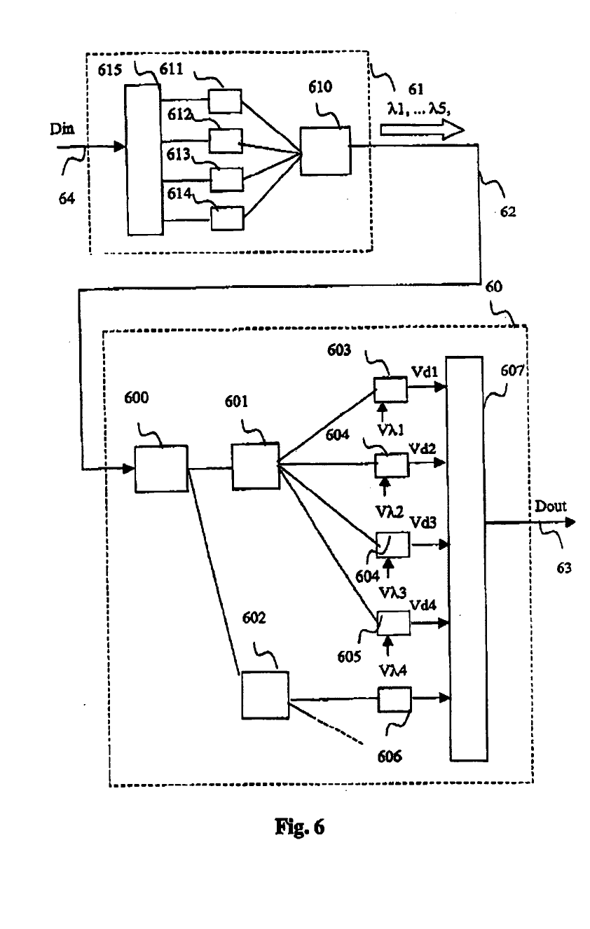

FIG. 6 illustrates a communication system using several photodetectors 10 like those represented with reference to the previous figures.

The communication system comprises an optical emitter 61, an optical receiver 60 and an optical link 62 (for example an optical fibre).

The receiver 60 receives an optical signal comprising several multiplexed wavelengths through the link 62 and emits a decoded digital signal Dout on the output 63 corresponding to the received optical signal. In particular it comprises:
couplers 600 to 602 used to duplicate an optical input signal on several outputs;
photodetectors 603 to 606 of the same type as the photodetector 10; and
a processing unit 607.

The coupler 600 has two outputs, one of which is connected to the input of coupler 601 and the other is connected to input of 602. The coupler 601 has four outputs connected to the inputs of photodetectors 603 to 605, and the coupler 602 has outputs connected to the inputs of photodetector 606.

Thus, each of the photodetectors 603 to 606 receives an optical beam similar to the beam carried on link 62, at its input.

Each of the bias electrodes 24 of photodetectors 603 to 606 is connected to a different potential V_{nDPLC} enabling the photodetectors 603 to 606 to detect optical beams with a distinct wavelength. Thus, for example, photodetectors 603, 604 and 605 are connected to potentials V_{nDPLC1}, V_{nDPLC2} and V_{nDPLC3} respectively, equal to 0 V, 21 V and 45 V respectively. Therefore, they detect signals with wavelengths equal to 1555 nm, 1550 nm and 1545 nm respectively (see curves in FIG. 5).

Therefore, the output from each of the photodetectors 603 to 606 has a current that depends on the component of the input signal associated with the corresponding wavelength of the photodetector. It is connected to the processing unit 607 that converts the result output by each photodetector into a digital signal Dout according to a predetermined mode (transmission on distinct physical lines, time multiplexing, frequency multiplexing, etc).

Therefore, the receiver 60 decodes the incident optical signal in a reliable, flexible and fast manner. Therefore, it is particularly suitable for high-speed communications. It is also easily configurable as a function of the number of channels (each channel corresponding to a determined wavelength).

The emitter 61 receives a digital signal Din on an input 64 to emit an optical signal representative of the Din signal on the link 62.

The emitter comprises a digital demultiplexing unit 615 responsible for transmitting part of the incident signal Din to the laser emitters 611 to 614. Each of the lasers 611 to 614 emits a signal at a different wavelength corresponding to the input data and supplies power to a coupler 610 that emits the optical signal resulting from the different signals produced by each laser 611 to 614, on the link 62.

In summary, the digital signal Din is transmitted by the emitter 61 on the link 62 in the form of an optical beam. The optical beam is input to the receiver 60 that processes it to produce a resultant digital signal Dout that corresponds to the input signal Din if there are no transmission errors.

Depending on the embodiment, the tuneability potentials of the photodetectors 603 to 606 are fixed by an initial configuration.

According to one variant of the invention, the tuneability potentials vary dynamically, for example under the control of a processing unit 607 or any other control means. In particular, the control means may act on tuneability potentials for:
adaptation to different emitters that can emit signals to the receiver 60;
reception of an optical signal corresponding to one or several determined frequencies (in advance or by communication protocol);
precise setting on a given wavelength as a function of measured drifts (the tuneability potential being determined to correspond to a maximum sensitivity (spectrum peak) of the signal received at the reference wavelength).

According to one variant of the receiver, several photodetectors are grouped in a single component according to a variant by which a photodetector can detect several wavelengths independently of each other (for example this may be a photodetector with several bias and detection electrodes, as illustrated previously).

Other applications of the photodetector 10 are envisaged, particularly optimisation of a wavelength demultiplexing system (for example of the AWG type). According to a first embodiment, one or several photodetectors 10 are placed at the outputs of a wide spectral band demultiplexer to select channels with more finely defined wavelengths. According to a second embodiment, one or several photodetectors 10 are placed at the outputs from a demultiplexer with a transfer function that is spectrally selective but is not flat. Thus, a flat global transfer function is obtained by multiplication of the transfer functions of the demultiplexer and the adapted photodetector(s). Thus, these two embodiments provide a means of filtering an optical signal.

Obviously, the invention is not limited to the example embodiments mentioned above.

In particular, those skilled in the art could make any variant to the shape of the photodetector structure, and the composition of the zone with variable index.

Similarly, the manufacturing method is not limited to the method described but includes any manufacturing method enabling association of a photodetector and an electro-optical material that is preferably isotropic along a plane perpendicular to the propagation of the light beam(s) and that may be subjected to at least one electrical field along the axis of propagation of the light beam(s).

The invention is also applicable to the case in which the electro-optical zone is composed of a material that is not nano-PDLC, but which has isotropic electro-optical properties in a transverse plane.

Obviously, the invention is also applicable to the case in which the geometries of the electrodes are different from those described (provided that they enable application of an electrical bias field parallel to the axis of propagation of the incident beam) and/or are composed of a transparent or semi-transparent material for the incident beam, but not of the ITO type.

Furthermore, the invention may be applicable to the case in which the other parts of the photodetector are different from the parts in the described embodiment, particularly for the absorbent zone or the ends. In particular, these may be made from a material other than glass fibre or glass substrate and in particular will be transparent or quasi-transparent at the end(s) through which an optical beam is input.

For example, according to the invention, the Bragg mirrors are not necessarily dielectric DBRs, they could also be semiconducting DBRs or vice-versa.

Moreover, the invention is applicable not only to the case in which the component is coupled to one or several fibres directly (the component is then sufficiently close to the fibre(s) so that the air diffraction effect is negligible) or with an interface comprising one or several collimators (in the form of an optical network or a coupling lens) but also any other incident beam reception medium, particularly such as free air.

In some variant embodiments of the invention, the absorbent zone is replaced by a quantum well zone. However, an absorbent zone gives a better coverage (and therefore the corresponding photodetector has a better efficiency) than a quantum well zone.

Those skilled in the art could also make any variant to the means used to create potentials for photodetection and/or to tune the photodetector. Thus, the transparent electrodes can be replaced, for example, by annular electrodes placed around the photodetector to create photodetection and/or tuneability electrical fields.

Depending on particular embodiments, the photodetector enables operation in transverse monomode; at least one optical element inside the photodetector cavity has a variable optical loss profile in a plane perpendicular to a propagation axis of a light beam (or a transverse plane) passing through the cavity so as to encourage a transverse mode of the photodetector. Thus, for example the photodetector possesses a profile in a transverse plane that encourages fundamental transverse mode to the detriment of other transverse modes, or on the other hand it encourages the first transverse mode to the detriment of the fundamental transverse mode. Thus, immunity to noise is better if the received beam to be decoded operates on a single transverse mode. Therefore, this profile flexibly gives priority either to fundamental transverse mode or to another mode, in a manner that is easy to manufacture. In particular, the variable profile may be made by insolating the area close to the axis of the photodetector and the area further away from it differently; thus, the variable phase zone contains two concentric zones, for example with diameters equal to 100 μm and 4 μm respectively, the binary profile having a discontinuity in the size of the droplets between the two zones. The first central zone with a radius w equal to 2 μm comprises droplets with a diameter of about 100 nm smaller than the diameter of the droplets contained in the second zone that is close to 500 nm.

The various embodiments of the invention are used in applications in the telecommunications field (particularly in the low or high-speed data transmission, data transmission on multimode fibres, etc.) and also in many other domains involving photodetectors (particularly in medicine).

In particular, the photodetector according to the invention may be used as a data receiver or a filter and/or coupled to demultiplexing, amplification, shaping means for optical signals.

1. Resonant cavity enhanced photodetector (10, 60) comprising a first (20) and a second (21) reflection means forming the said cavity and means of absorption (22) of photons of an incident light beam (17), wherein it also comprises at least one electro-optical element inside the said cavity, including an isotropic material in a transverse plane, intended for tuning the wavelength of the said photodetector.

2. Photodetector according to claim 1, wherein it also comprises first means (24, 23) of application of a variable electrical field to the said electro-optical element as a function of at least an electrical voltage applied to the said photodetector.

3. Photodetector according to claim 2, wherein the first means of application of an electrical field comprise at least one first transparent or semi-transparent electrode (24, 23) enabling application of the said electrical field to the said electro-optical elements and passage of the said incident light beam through these electrodes.

4. Photodetector according to claim 3, wherein the said electrode(s) is (are) of the ITO type.

5. Photodetector according to claim 1, wherein at least one of the said electro-optical elements comprises a nano-PDLC type material.

6. Photodetector according to claim 1, wherein the said photon absorption means comprise a bulk absorbent zone.

7. Photodetector according to claim 1, wherein it comprises second means (27, 23) of application of an electrical field to the absorbent zone.

8. Photodetector according to claim 1, wherein the optical loss profile of the said at least electro-optical element(s) is (are) variable in a plane perpendicular to an axis of propagation of the said light beam so as to favor a transverse mode of the said photodetector.

9. Matrix of components wherein the said matrix comprises at least two photodetectors according to claim 1.

10. Matrix of components according to claim 9 wherein each photodetector in the matrix comprises:
means of application of an electrical field for tuning a wavelength associated with the said photodetector, such that the matrix is capable of tuning several wavelengths;
and detection means associated with each of the tuned wavelengths.

11. High-speed telecommunications system, wherein it comprises means (60) for reception of at least one incident beam, themselves comprising at least one resonant cavity enhanced photodetector according to claim 1.

12. System according to claim 11, wherein the said reception means comprise means of redirection (600, 601, 602) of an incident beam to each of the photodetectors.

13. System according to claim 12, wherein the redirection means form a coupler (600, 601, 602).

14. System according to claim 11, wherein the said reception means comprise at least two photodetectors (603 to 606) adapted to detecting light beams with distinct wavelengths.

15. System according to claim 11, wherein it comprises means of emission (61) of the said at least one incident beam.
